(19) United States
(12) Patent Application Publication
(10) Pub. No.: US 2011/0206334 A1
(43) Pub. Date: Aug. 25, 2011

(54) OPTICAL FIBRE SPLICING MODULE

(76) Inventors: Xin Liu, Shenzhen (CN); Binqiang Zeng, Shenzhen (CN); Bin Liu, Shenzhen (JP); Xiaozhou Guo, Shenzhen (CN)

(21) Appl. No.: 12/597,995

(22) PCT Filed: Apr. 28, 2008
(86) PCT No.: PCT/IB2008/004003

§ 371 Date: Nov. 18, 2010

(30) Foreign Application Priority Data
Apr. 28, 2007 (CN) 200710074255.2

(51) Int. Cl. G02B 6/44

(52) U.S. Cl. 385/135

(57) ABSTRACT

The invention relates to an optical fibre splicing module. The optical fibre splicing module includes a base and a cover board, with two operation planes being arranged on the base, i.e. an upper operation plane provided with an optical fibre cable core winding area, a bare fibre winding and fusion welding area and an adapter holder, and a lower operation plane provided with a fibre pigtail winding area. 16 or 32 bayonets are arranged on the adapter holder, the bayonets are longitudinally arranged along the vertical direction of the operation planes. The size of the bayonets is just suitably connected to the vertically placed adapters. Not only the number of bayonets is increased to a number meeting the requirements of the optical splitter, but also the volume of the entire optical fibre splicing module can be ensured not to be increased by using the arrangement of the bayonets and the matching method of the bayonets with the vertically arranged adapters. Also, the integrity degree can be improved and the requirements of the optical splitter can be met, without changing the shape and size of existing adapters.

This application was filed on 28 Apr. 2008, as a PCT International Patent application in the name of Shenzhen Century Man Communication Equipment Co., Ltd., a Chinese national corporation, applicant for the designation of all countries except the U.S., and Xin Liu, a citizen of China, Binqiang Zeng, a citizen of China, Bin Liu, a citizen of China, and Xiaozhou Guo, a citizen of China, applicants for the designation of the U.S. only, and claims priority to Chinese Patent Application Serial No. 200710074255.2 filed on 28 Apr. 2007.

### FIELD OF THE INVENTION

The present invention generally relates to telecommunication devices, and more particularly, to an optical fibre splicing module.

### BACKGROUND OF THE INVENTION

An optical fibre cable distribution frame is a cable distribution connection device between optical fibre cables and optical communication devices, which includes an optical fibre cable fixing and protecting apparatus, an optical fibre terminating apparatus, a fibre pigtail connecting and allocating apparatus, and a fibre pigtail winding apparatus. In order to accomplish the functions of optical fibre fixing and protecting, optical fibre terminating, cable adjustment, and optical fibre cable core and pigtail protecting, etc., the existing optical fibre splicing module as disclosed in Patent Application Serial No. ZL00251713.2 comprises a base and a cover board, with two operation planes being arranged on the base, i.e. an upper operation plane and a lower operation plane. The upper operation plane is provided with an optical fibre cable core winding area, a bare fibre winding and fusion welding area and a step-shaped adapter holder, while the lower operation plane is provided with a fibre pigtail winding area. Since the adapter holder is step-shaped and the adapter bayonets are laterally arranged (i.e., the plane where the longer side of its section plane resides is parallel with the plane of the base), only limited number of the adapter bayonets can be snapped to the adapter holder in the lateral direction, resulting in a limited capacity of 8 or 12 adapter bayonets being snapped. Particularly for the optical splitter widely used, the resulting splicing number is generally a power of 2, such as 16 or 32 mostly. Although the maximum splicing number in the prior art is 12, only 8 bayonets can be used because 12 is not a power of 2. Thus, the integrity degree is significantly reduced and can not meet the requirements of an optical splitter.

### SUMMARY OF THE INVENTION

The present invention provides an optical fibre splicing module to address the problems of the existing optical fibre splicing module which has low integrity degree and cannot meet the requirements of an optical splitter.

In order to solve the above technical problems, the technical solution employed is as follows:

an optical fibre splicing module, including a base and a cover board, two operation planes being arranged on the base, i.e. an upper operation plane provided with an optical fibre cable core winding area, a bare fibre winding and fusion welding area and an adapter holder, and a lower operation plane provided with a fibre pigtail winding area, characterized in that: 16 or 32 bayonets are arranged on said adapter holder, said bayonets are longitudinally arranged along the vertical direction of the operation planes, lower slots matched with the adapter shoulders are arranged on the lower side of the bayonets, and sealing blocks with upper slots on its bottom plane matched with the adapter shoulders are arranged on the upper side of the bayonets, both ends of the sealing blocks and both sides of the bayonets are connected by matched grooves and protrusions, the size of said bayonets is just suitably connected to the vertically placed adapters.

Said protrusions are provided at both ends of the sealing blocks, while said grooves are provided at both sides of the bayonets.

Said adapter holder and said base are connected by general means, and the adapter holder can be replaced as needed.

After using the above technical solution, since 16 or 32 bayonets are arranged on the adapter holder, the bayonets are longitudinally arranged along the vertical direction of the operation planes, lower slots matched with the adapter shoulders are arranged on the lower side of the bayonets, and sealing blocks with upper slots on its bottom plane matched with the adapter shoulders are arranged on the upper side of the bayonets, both ends of the sealing blocks and both sides of the bayonets are connected by matched grooves and protrusions, the size of the bayonets is just suitably connected to the vertically placed adapters, not only the number of bayonets is increased to a number meeting the requirements of the optical splitter, but also the volume of the entire optical fibre splicing module can be ensured not to be increased by using the arrangement of the bayonets and the matching method of the bayonets with the vertically arranged adapters. Also, the integrity degree can be improved and the requirements of the optical splitter can be met, without changing the shape and size of existing adapters.

### BRIEF DESCRIPTION OF THE DRAWINGS

FIG. 1 is a schematic drawing of the structure according to a first embodiment of the present invention;

FIG. 2 is a schematic drawing of snapping structure between an adapter and an adapter holder in the first embodiment of the present invention;

FIG. 3 is a schematic drawing of the structure according to an second embodiment of the present invention; and

FIG. 4 is a schematic drawing of snapping structure between an adapter and an adapter holder in the second embodiment of the present invention.

### DETAILED DESCRIPTION OF THE INVENTION

### First Embodiment

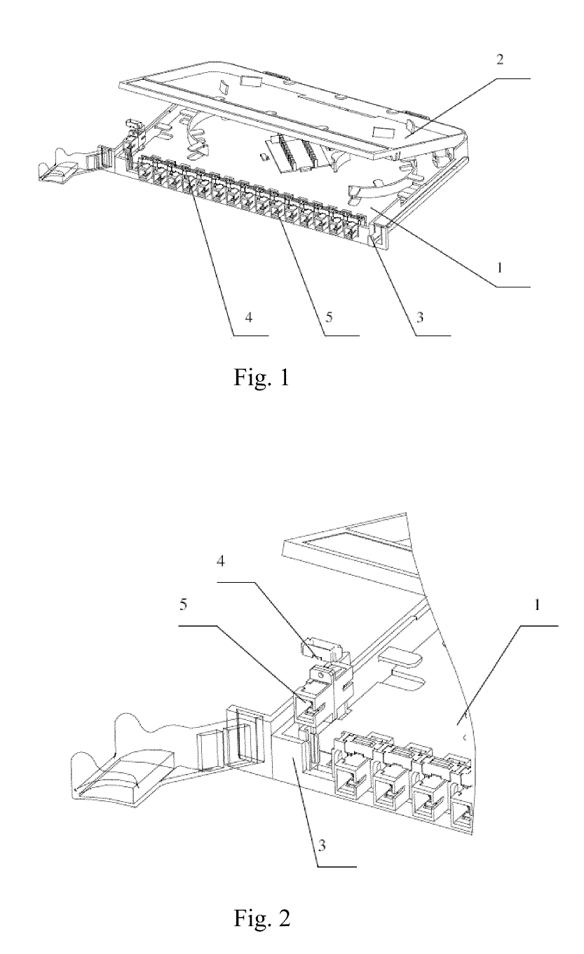

As shown in FIGS. 1 and 2, an optical fibre splicing module includes a base and a cover board, with two operation planes being arranged on the base, i.e. an upper operation plane provided with an optical fibre cable core winding area, a bare fibre winding and fusion welding area and an SC adapter holder, and a lower operation plane provided with a fibre pigtail winding area. 16 bayonets are arranged on the SC adapter holder. The bayonets are longitudinally arranged along the vertical direction of the operation planes. Lower slots matched with the adapter shoulders are arranged on the lower side of the bayonets, and sealing blocks with upper slots on its bottom plane matched with the adapter shoulders are arranged on the upper side of the bayonets, the sealing blocks and the bayonets are connected by protrusions at both ends of the sealing blocks and grooves at both sides of the bayonets. Said adapter holder and said base are connected by general means, and the adapter holder can be replaced as needed.

### Second Embodiment

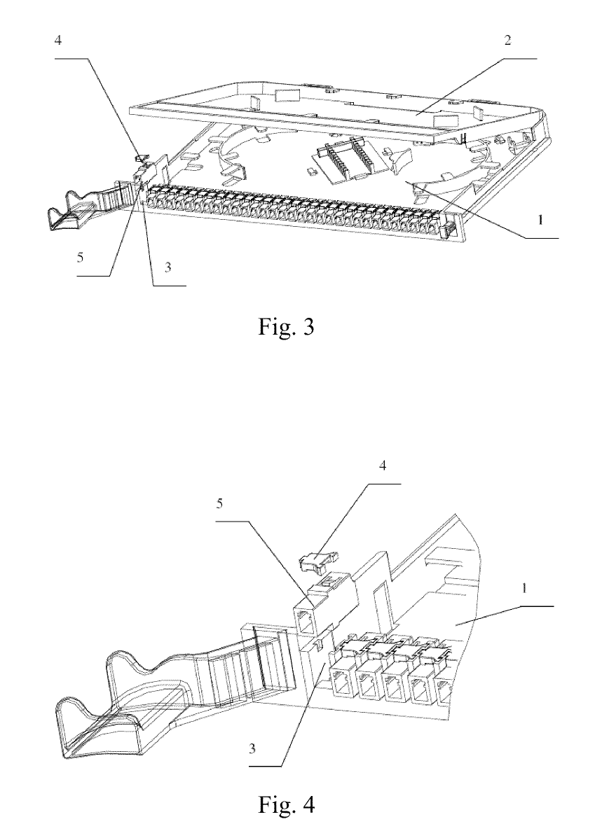

An optical fibre splicing module as shown in FIGS. 3 and 4 includes a base and a cover board, with two operation planes being arranged on the base, i.e. an upper operation plane provided with an optical fibre cable core winding area, a bare fibre winding and fusion welding area and an LC adapter holder, and a lower operation plane provided with a fibre pigtail winding area. 32 bayonets are arranged on the LC adapter holder. The bayonets are longitudinally arranged along the vertical direction of the operation planes. Lower slots matched with the adapter shoulders are arranged on the lower side of the bayonets, and sealing blocks with upper slots on its bottom plane matched with the adapter shoulders are arranged on the upper side of the bayonets, the sealing blocks and the bayonets are connected by protrusions at both ends of the sealing blocks and grooves at both sides of the bayonets. Said adapter holder and said base are connected by general means, and the adapter holder can be replaced as needed.

1. An optical fibre splicing module, including a base and a cover board, two operation planes being arranged on the base, i.e. an upper operation plane provided with an optical fibre cable core winding area, a bare fibre winding and fusion welding area and an adapter holder, and a lower operation plane provided with a fibre pigtail winding area, comprising:
16 or 32 bayonets are arranged on said adapter holder, said bayonets are longitudinally arranged along the vertical direction of the operation planes, lower slots matched with the adapter shoulders are arranged on the lower side of the bayonets, and sealing blocks with upper slots on its bottom plane matched with the adapter shoulders are arranged on the upper side of the bayonets, both ends of the sealing blocks and both sides of the bayonets are connected by matched grooves and protrusions, the size of said bayonets is just suitably connected to the vertically placed adapters.

2. The optical fibre splicing module of claim 1, wherein:
said protrusions are provided at both ends of the sealing blocks, while said grooves are provided at both sides of the bayonets.

3. The optical fibre splicing module of claim 1, wherein:
said adapter holder and said base are connected by general means, and the adapter holder can be replaced as needed.
